(19) United States
(12) Patent Application Publication
(10) Pub. No.: US 2025/0377241 A1
(43) Pub. Date: Dec. 11, 2025

(54) LASER INTENSITY MEASURING DEVICE, LASER PROCESSING APPARATUS HAVING THE LASER INTENSITY MEASURING DEVICE, METHOD FOR MEASURING LASER INTENSITY, AND METHOD FOR LASER PROCESSING

(71) Applicant: DISCO CORPORATION, Tokyo (JP)

(72) Inventor: Keiichiro NIITSU, Tokyo (JP)

(73) Assignee: DISCO CORPORATION, Tokyo (JP)

(21) Appl. No.: 19/226,563

(22) Filed: Jun. 3, 2025

(30) Foreign Application Priority Data
Jun. 6, 2024 (JP) 2024-092205

(51) Int. Cl. G01J 1/42; G01J 1/04; G01J 1/44

(52) U.S. Cl. CPC G01J 1/4257; G01J 1/0407; G01J 1/44; G01J 2001/0481; G01J 2001/446

(57) ABSTRACT

A laser intensity measuring device includes a diffraction optical element configured to split a laser beam into a plurality of branch beams; an integrating sphere including an entrance port through which one of the laser beam or the plurality of branch beams enters the integrating sphere, an exit port through which at least one of the plurality of branch beams exits the integrating sphere, and an inner wall on which the other of the plurality of branch beams impinge; and a sensor configured to measure an intensity of the other of the plurality of branch beams reflected by the inner wall.

### CROSS REFERENCE TO RELATED APPLICATION

This application is based upon and claims the benefit of priority from the prior Japanese Patent Application No. 2024-092205 filed on Jun. 6, 2024; the entire contents of which are incorporated herein by reference.

### FIELD

The present invention relates to a laser intensity measuring device, a laser processing apparatus having the laser intensity measuring device, a method for measuring laser intensity, and a method for laser processing.

### BACKGROUND

Conventionally, laser processing apparatuses capable of measuring intensity of a laser beam have been known. Such laser processing apparatuses are disclosed in, for example, Japanese Patent Application Laid-Open Publication No. 2013-091087. According to the referenced publication, a laser processing apparatus is provided with an output measuring means for measuring output of a laser beam located at a position adjacent to a chuck table that holds a workpiece.

### SUMMARY

The laser processing apparatus disclosed in the referenced publication is configured to measure the output of the laser beam by operating the output measuring means to receive the laser beam while laser processing is not being performed on the workpiece. In other words, laser processing is not performed while the output of the laser beam is being measured. This alternating processing flow has been a factor that hinders improvement in productivity of the laser processing apparatus.

This problem is not limited to the laser processing apparatus disclosed in referenced publication but may occur similarly in any laser processing apparatus that measures intensity of a laser beam used for processing. The present disclosure is made in view of such a problem, and an object thereof is to provide a technique that enables a laser beam to be used for processing while intensity of the laser beam is being measured.

According to an aspect of the present disclosure, a laser intensity measuring device includes a diffraction optical element configured to split a laser beam into a plurality of branch beams; an integrating sphere including an entrance port through which one of the laser beam or the plurality of branch beams enters the integrating sphere, an exit port through which at least one of the plurality of branch beams exits the integrating sphere, and an inner wall on which the other of the plurality of branch beams impinge; and a sensor configured to measure an intensity of the other of the plurality of branch beams reflected by the inner wall.

According to another aspect of the present disclosure, a laser processing apparatus includes the laser intensity measuring device and an oscillator configured to emit the laser beam. The at least one of the plurality of branch beams exiting through the exit port irradiates a workpiece.

According to another aspect of the present disclosure, a method for measuring a laser intensity includes splitting a laser beam into a measurement laser beam and a processing laser beam, splitting the laser beam includes causing the laser beam to enter a diffraction optical element, causing a plurality of branch beams branched from the laser beam by the diffraction optical element to enter an integrating sphere through an entrance port of the integrating sphere, and directing at least one of the plurality of branch beams to an exit port of the integrating sphere and directing the other of the plurality of branch beams to an inner wall of the integrating sphere. The method includes measuring an intensity of the other of the plurality of branch beams reflected by the inner wall.

According to another aspect of the present disclosure, a method for laser processing includes splitting a laser beam into a measurement laser beam and a processing laser beam, splitting the laser beam includes causing the laser beam to enter a diffraction optical element, causing a plurality of branch beams branched from the laser beam by the diffraction optical element to enter an integrating sphere through an entrance port of the integrating sphere, and directing at least one of the plurality of branch beams to an exit port of the integrating sphere and directing the other of the plurality of branch beams to an inner wall of the integrating sphere. The method includes measuring an intensity of the other of the plurality of branch beams reflected by the inner wall. The method includes irradiating a workpiece with the at least one of the plurality of branch beams exiting the exit port.

According to the present disclosure, a technique that enables a laser beam to be used for processing while intensity of the laser beam is measured is provided.

### BRIEF DESCRIPTION OF THE DRAWINGS

FIG. 1 is a schematic diagram illustrating an exemplary configuration of a laser processing apparatus according to a first embodiment.

FIG. 2 is a schematic diagram illustrating an exemplary configuration of a laser emitting unit according to the first embodiment.

FIG. 3 is a flowchart to illustrate a laser processing method to be performed in the laser processing apparatus according to the first embodiment.

FIG. 4 is a schematic diagram illustrating an exemplary configuration of a laser emitting unit according to a second embodiment.

### DESCRIPTION OF EMBODIMENTS

### First Embodiment

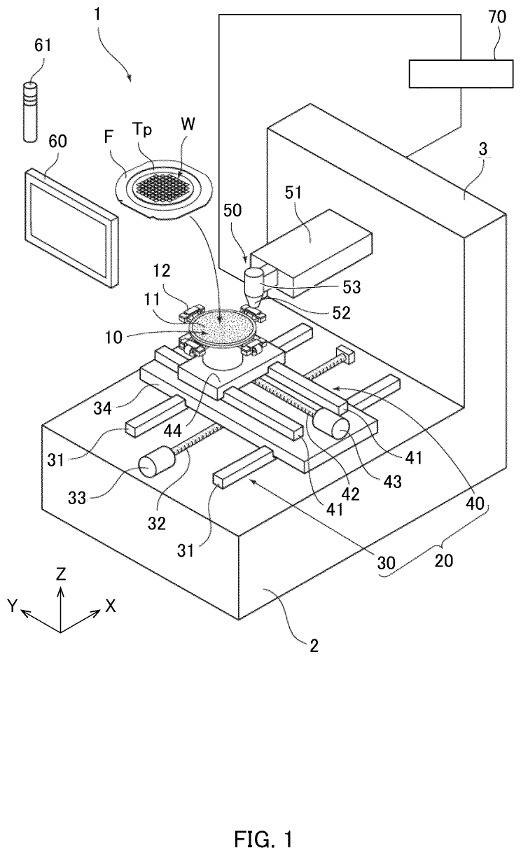

FIG. 1 is a schematic diagram illustrating an exemplary configuration of a laser processing apparatus 1 according to a first embodiment. An X-axis direction, a Y-axis direction, and a Z-axis direction shown in FIG. 1 are orthogonal to one another. The X-axis direction and the Y-axis direction are approximately horizontal directions, and the Z-axis direction is a vertical direction (approximately upright direction). First, a configuration of the laser processing apparatus 1 will be described with reference to FIG. 1.

The laser processing apparatus 1 is configured to process a workpiece held on a chuck table 10 by emitting a laser beam from a laser emitting unit 50. The workpiece is not particularly limited, but may be, for example, a wafer W made of silicon or SiC. In the laser processing apparatus 1, the wafer W being the workpiece is handled as a part of a frame unit. The frame unit is, as shown in FIG. 1, composed of a ring frame F and the wafer W, where the wafer W is attached to the ring frame F with a tape Tp that closes an opening of the ring frame F.

As shown in FIG. 1, the laser processing apparatus 1 includes a chuck table 10 for holding the wafer W, a horizontal movement unit 20 for moving the wafer W in the horizontal direction, a laser emitting unit 50 for emitting a laser beam at the wafer W, a display unit 60, a notification unit 61, and a controller 70. The laser processing apparatus 1 includes an exterior cover, which is not shown, and the display unit 60 and the notification unit 61 are mounted on an outer surface of the exterior cover.

The chuck table 10 includes a holder surface 11 for holding the wafer W thereon, and a clamping device 12 for gripping the ring frame F. The holder surface 11 is a surface of a porous plate, on which the wafer W is placed via the tape Tp. The chuck table 10 is configured to hold the wafer W on the holder surface 11 by, in a state where the wafer W is placed on the holder surface 11 and the ring frame F is clamped by the clamping device 12, activating a suction source, which is not shown, to generate a negative pressure at the holder surface 11 so that the wafer W placed on the holder surface 11 may be suctioned and held thereon.

The horizontal movement unit 20 is configured to move the chuck table 10 horizontally with respect to a base 2 of the laser processing apparatus 1, thereby moving the wafer W held on the chuck table 10 in the horizontal direction. The horizontal movement unit 20 includes an X-axis direction movement unit 30 and a Y-axis direction movement unit 40. The X-axis direction movement unit 30 may move a table 34 in the X-axis direction, and includes a pair of guide rails 31 fixed to the base 2, a ball screw 32, a motor 33, and the table 34. On a rear side of the table 34, a nut (not shown) is formed and screwed with the ball screw 32. The Y-axis direction movement unit 40 may move a table 44 in the Y-axis direction, and includes a pair of guide rails 41 fixed to the table 34, a ball screw 42, a motor 43, and the table 44. On a rear side of the table 44, a nut (not shown) is formed and screwed with the ball screw 42.

The Y-axis direction movement unit 40 is configured to move the table 44 in the Y-axis direction along the guide rails 41 by rotating the ball screw 42 with the motor 43. Thereby, the chuck table 10 fixed to the table 44 may be moved in the Y-axis direction. Similarly, the X-axis direction movement unit 30 is configured to move the table 34 in the X-axis direction along the guide rails 31 by rotating the ball screw 32 with the motor 33. Thereby, the chuck table 10, which is fixed to the table 44 of the Y-axis direction movement unit 40 provided on the table 34, may be moved in the X-axis direction.

The laser emitting unit 50 is a unit fixed to a column 3 erecting from the base 2 and includes a laser oscillator 51 that emits a laser beam, a condenser 52 that focuses the laser beam to irradiate the wafer W, and a laser intensity measuring device 53 disposed on an optical path between the laser oscillator 51 and the condenser 52.

The laser oscillator 51 may be selected preferably depending on the type of wafer W. The laser oscillator 51 is not particularly limited but may be, for example, a YAG laser oscillator or a YVO laser oscillator. The condenser 52 focuses the laser beam emitted from the laser oscillator 51 onto the surface of the wafer W. The laser intensity measuring device 53 splits the laser beam emitted from the laser oscillator 51, measures an intensity of a part of the laser beam, and directs the remainder of the beam toward the condenser 52.

The display unit 60 may display information, such as an operating status of the laser processing apparatus 1, to an operator. The display unit 60 may include, for example, a touch panel display and may also be used as an operation unit for the operator to input information related to the laser processing.

The notification unit 61 may provide information, such as the operating status of the laser processing apparatus 1, to the operator. The notification unit 61 may be, for example, an LED lamp that visually notifies the operating status by lighting behaviors or color thereof, or a speaker that audibly notifies the operating status using music or voice. The operating status to be notified by the notification unit 61 may include, for example, a state in which the wafer is being irradiated with the laser beam at an appropriate intensity or a state in which the wafer is being irradiated with the laser beam at an inappropriate intensity.

The controller 70 is configured to control operations of the components in the laser processing apparatus 1. The controller 70 may control, for example, a suction source (not shown) of the chuck table 10, the motors (motor 33 and motor 43) of the horizontal movement unit 20, and the laser oscillator 51 of the laser emitting unit 50. The controller 70 includes, for example, a processor that executes various processes and a storage (memory) that stores various parameters and programs. By executing a program, the processor may control the operations of the components in the laser processing apparatus 1.

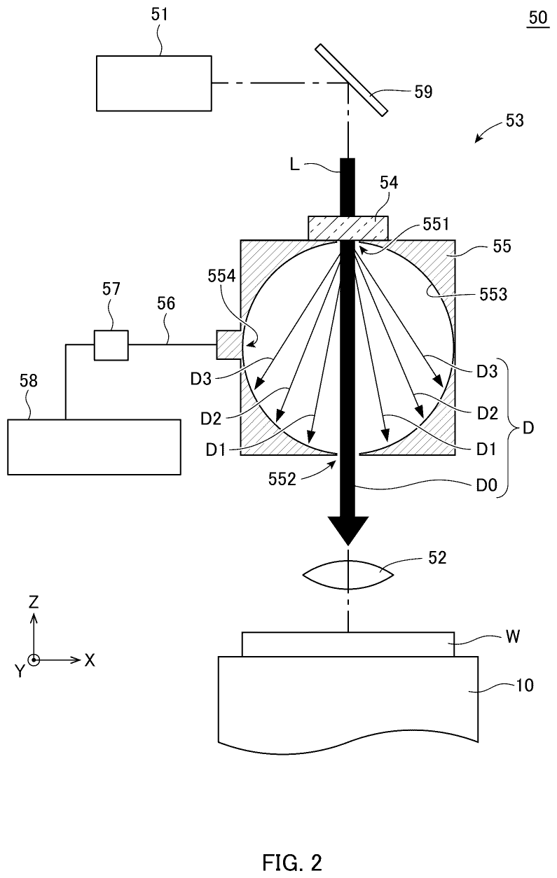

FIG. 2 is a schematic diagram illustrating an exemplary configuration of the laser emitting unit 50 according to the first embodiment. With reference to FIG. 2, a configuration of the laser emitting unit 50, particularly a configuration of the laser intensity measuring device 53 included in the laser emitting unit 50, will be described in detail.

The laser emitting unit 50, which includes the laser intensity measuring device 53, further includes the laser oscillator 51 for emitting a laser beam, the condenser 52 for focusing the laser beam onto the wafer W, and a mirror 59 for deflecting the laser beam toward the condenser 52. The laser intensity measuring device 53 is disposed between the mirror 59 and the condenser 52 on the optical path within the laser emitting unit 50. In other words, the laser emitting unit 50 is configured to irradiate the wafer W with the laser beam emitted from the laser oscillator 51 via the mirror 59 and the laser intensity measuring device 53 using the condenser 52.

The laser intensity measuring device 53 includes a diffraction optical element 54, an integrating sphere 55, a sensor 57, and an intensity calculation unit 58. The diffraction optical element 54 is an optical element that splits a laser beam L entering the laser intensity measuring device 53 into a measurement laser beam for measuring and a processing laser beam for laser processing. The diffraction optical element 54 is, for example, a transmissive diffraction optical element with known diffraction efficiency and is disposed at an entrance port 551 of the integrating sphere 55. The diffraction optical element 54 may include any type of diffraction grating, including, for example, a blazed diffraction grating or a VPH diffraction grating. The diffraction optical element 54 is configured to split the laser beam L into a plurality of branch beams, each corresponding to a diffracted beam D of different order.

In the laser intensity measuring device 53, some of the plurality of branch beams (diffracted beams D) split by the diffraction optical element 54 are used as the processing laser beam, and the remaining beams are used as the measurement laser beams. In the present embodiment, a zero-order diffracted beam D0, which travels straight through the diffraction optical element 54, is used as the processing laser beam, while other diffracted beams of different orders (diffracted beam D1, diffracted beam D2, diffracted beam D3, . . . ) are used as the measurement laser beams.

However, the combination of the processing laser beam and the measurement laser beams is not limited to this example. At least one of the diffracted beams D split by the diffraction optical element 54 may be used as the processing laser beam. Preferably, the processing laser beam includes the diffracted beam of an order with the highest diffraction efficiency. In this example, it is desirable that the diffraction optical element 54 is designed so that the zero-order diffracted beam has the highest diffraction efficiency (e.g., 99.6%).

The integrating sphere 55 (first integrating sphere) is an optical element that directs the measurement laser beams to the sensor 57 and the processing laser beam to the condenser 52. The integrating sphere 55 includes an entrance port 551, exit ports (exit port 552 and exit port 554), and an inner wall 553, and the entrance port 551 and the exit port 552 are located on an optical axis of the condenser 52.

The diffraction optical element 54 is disposed at the entrance port 551. More specifically, the diffraction optical element 54 is disposed on an outer surface of the integrating sphere 55 so as to cover the entrance port 551. Accordingly, in the laser intensity measuring device 53, the diffracted beams D, which are branch beams split by the diffraction optical element 54, enter the integrating sphere 55 through the entrance port 551.

The exit port 552, which is one of the two exit ports of the integrating sphere 55, is an exit port where the zero-order diffracted beam DO serving as the processing laser beam exits the integrating sphere 55. The exit port 552 is located on the optical path of the zero-order diffracted beam D0, which travels straight through the diffraction optical element 54, at a position opposite to the entrance port 551. Laser beams that do not travel straight toward the exit port 552, i.e., diffracted beams for measurement (such as diffracted beam D1, diffracted beam D2, diffracted beam D3, etc.) other than the zero-order diffracted beam, impinge on the inner wall 553, which has high reflectance and superior diffusivity, and are diffused by reflecting on the inner wall 553.

The exit port 554, which is the other of the two exit ports of the integrating sphere 55, is an exit port through which the diffracted beams other than the zero-order serving as the measurement laser beams exit the integrating sphere 55. The diffracted beams other than the zero-order that exit the integrating sphere 55 through the exit port 554 are spatially integrated through repeated diffusive reflection on the inner wall 553, thereby eliminating the directional dependence that existed when emitted from the diffraction optical element 54 and resulting in a light beam with averaged intensity of the diffracted beams other than the zero-order. The light exited through the exit port 554 is guided to the sensor 57 via an optical fiber 56.

The sensor 57 (first sensor) measures the intensity of the measurement laser beam that is diffusely reflected by the inner wall 553 and enters via the optical fiber 56. The sensor 57 may be any device capable of measuring laser beam intensity, such as a photodetector including a photodiode or a thermal sensor including a thermopilc.

The intensity calculation unit 58 calculates the intensity of the laser beam L entering the laser intensity measuring device 53 or the intensity of the diffracted beam D0 exiting the laser intensity measuring device 53 based on output signals from the sensor 57. More specifically, the intensity calculation unit 58 calculates the intensity of the laser beam L or the intensity of the diffracted beam D0 based on the measured intensity of the measurement laser beam and the diffraction efficiency of the diffraction optical element 54.

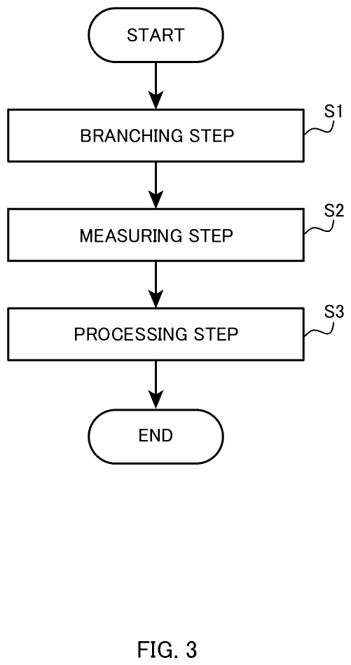

FIG. 3 is a flowchart to illustrate a laser processing method to be performed in the laser processing apparatus 1 according to the first embodiment. The laser processing performed in accordance with the method shown in FIG. 3 will be described below. The laser processing method shown in FIG. 3 includes a branching step, a measuring step, and a processing step. Among these, the branching step and measuring step compose a laser intensity measuring method performed by the laser intensity measuring device 53 of the laser processing apparatus 1.

When laser processing starts, the controller 70 of the laser processing apparatus 1 controls the laser emitting unit 50 to emit a laser beam L from the laser oscillator 51. The laser beam L emitted from the laser oscillator 51 is deflected toward the laser intensity measuring device 53 by the mirror 59 and enters the laser intensity measuring device 53. In the laser intensity measuring device 53, the branching step (Step S1) is performed to split the laser beam L into a measurement laser beam and a processing laser beam.

In the branching step, first, the laser beam L first is emitted and enters the diffraction optical element 54, and is split into a plurality of branch beams (diffracted beams D) by the diffraction optical element 54. The branch beams (diffracted beams D) exiting the diffraction optical element 54 proceed respectively at predetermined diffraction angles and enter the integrating sphere 55 through the entrance port 551. Among the plurality of diffracted beams D entering the integrating sphere 55, the zero-order diffracted beam D0 travels straight along the optical axis of the condenser 52 without being reflected by the inner wall 553, and is directed to the exit port 552 and exits the integrating sphere 55. Meanwhile, the other diffracted beams (diffracted beam D1, diffracted beam D2, diffracted beam D3, . . . ) deviate from the optical axis of the condenser 52 and are directed to the inner wall 553 within the integrating sphere 55.

In other words, the branching step includes causing the laser beam L to enter the diffraction optical element 54, causing the plurality of branch beams from the laser beam L branched by the diffraction optical element 54 to enter the integrating sphere 55 through the entrance port 551, directing at least one (diffracted beam D0) of the branch beams to the exit port 552, and directing the remaining branch beams (diffracted beams other than the diffracted beam D0) to the inner wall 553 of the integrating sphere 55.

After the branching step, the laser intensity measuring device 53 performs the measuring step (Step S2) to measure the intensity of the diffracted beams reflected by the inner wall 553. In the measuring step, the diffracted beams directed to the inner wall 553 diffusely reflect repetitively and finally exit through the exit port 554. The diffracted beams exited through the exit port 554 are directed to the sensor 57 via the optical fiber 56, and the intensities thereof are measured by the sensor 57.

The measurement result from the sensor 57 is output to the intensity calculation unit 58, which calculates the intensity of the laser beam L entering the laser intensity measuring device 53 or the intensity of the zero-order diffracted beam D0 exited the laser intensity measuring device 53. In other words, in the laser intensity measuring device 53, following the measuring step, the calculation step to compute the intensity of the incident light (laser beam) entering the laser intensity measuring device 53 or the intensity of the exiting processing light (laser beam) exiting the laser intensity measuring device 53 may be performed.

In the calculation step, as long as the intensity calculation unit 58 calculates the intensity of the laser beam L or the intensity of the zero-order diffracted beam D0 based on the measurement results (intensity of the other of the plurality of branch beams) and the diffraction efficiency of the diffraction optical element 54, the method for calculating these intensities is not particularly limited. The intensity calculation unit 58 may calculate the intensity of the laser beam L and the intensity of the zero-order diffracted beam D0 using the following formulas (1) and (2):

$$IL = ( X / T ) / ( 1 - Y / 100 ) \qquad ( 1 )$$

$$IO = ( X / T ) / ( 1 - Y / 100 ) * ( Y / 100 ) = IL * ( Y / 100 ) \qquad ( 2 )$$

In this context, IL represents the intensity of the laser beam L entering the laser intensity measuring device 53, and 10 represents the intensity of the zero-order diffracted beam D0 exiting the laser intensity measuring device 53. X represents a measurement output (measured value) from the sensor 57. Y represents a transmittance (%) of the zero-order beam through the diffraction optical element 54 and is in other words diffraction efficiency of the zero-order beam through the diffraction optical element 54. T represents a throughput of the integrating sphere 55. The throughput of the integrating sphere 55 is an index representing a degree of light loss due to diffusive reflection at the inner wall of the integrating sphere and is defined as a ratio of output light to incident light. Throughput is generally known to be inversely proportional to a square of a radius of the integrating sphere 55 and also depends on the reflectivity of the inner wall 553. Optionally, when calculating the intensities using the formulas (1) and (2), known design values of the diffraction optical element 54 and the integrating sphere 55 or experimental measurements may be applied to the values of the zero-order beam transmittance Y and the throughput T.

The laser processing apparatus 1 further performs the processing step (Step S3), in which the zero-order diffracted beam D0 exiting through the exit port 552 irradiates the wafer W. In the processing step, the zero-order diffracted beam D0 exiting the laser intensity measuring device 53 enters and exits the condenser 52 to irradiate the wafer W. By the condenser 52 focusing the diffracted beam D0 onto the wafer W, the wafer W is processed through ablation, where a portion of the wafer W is sublimated and evaporated by the laser energy concentrated in a small area, and a laser-processed groove is formed on the wafer W.

As described above, the laser intensity measuring device 53 may measure the intensity of the laser beam even while laser processing is being performed on the wafer W by executing the laser intensity measuring method, which includes the branching step and measuring step described above. Moreover, the laser processing apparatus 1 may irradiate the wafer W with the laser beam using the laser beam for processing the wafer W while measuring the intensity of the laser beam, by executing the laser processing method, which includes the branching step, the measuring step, and the processing steps described above. Therefore, according to the laser intensity measuring device 53 and the laser processing apparatus 1, laser processing may be continued without being interrupted by measurement of the laser intensity, thereby improving the productivity of laser processing with the wafer W.

In the laser processing apparatus 1, further, the controller 70 may control the components based on the intensity of the measurement laser beam measured in the measuring step. For example, the controller 70 may compare the intensity of the incident laser beam or the intensity of the processing laser beam, calculated by the intensity calculation unit 58 based on the intensity of the measurement laser beam, with a predetermined target intensity set in advance for laser processing, and determine whether the intensity of the processing laser beam to be used in the laser processing is appropriate or not. The controller 70 may control, for example, the laser emitting unit 50 and the notification unit 61 based on the result of the determination. More specifically, the controller 70 may adjust the intensity of the processing laser beam by controlling the laser emitting unit 50 so that the calculated intensity of the processing laser beam may approach the target intensity. Thereby, the laser processing apparatus 1 may perform laser processing while maintaining the appropriate beam intensity, and the processing quality may be improved. Meanwhile, if the calculated intensity deviates from the preset intensity exceeding an allowable range, the controller 70 may control the laser emitting unit 50 to suspend the laser processing. Thereby, the laser processing apparatus 1 may prevent laser processing from being performed at an inappropriate intensity, and quality of the laser processing may be improved. Furthermore, if the calculated intensity deviates from the preset intensity exceeding the allowable range, the controller 70 may control the notification unit 61 to alert the operator of the error. As such, laser processing with the laser beam having the inappropriate intensity may be suspended or continued according to a decision by the operator, providing both high productivity and high quality in laser processing. According to the laser processing apparatus 1 as above, both productivity and quality of laser processing may be improved.

### Second Embodiment

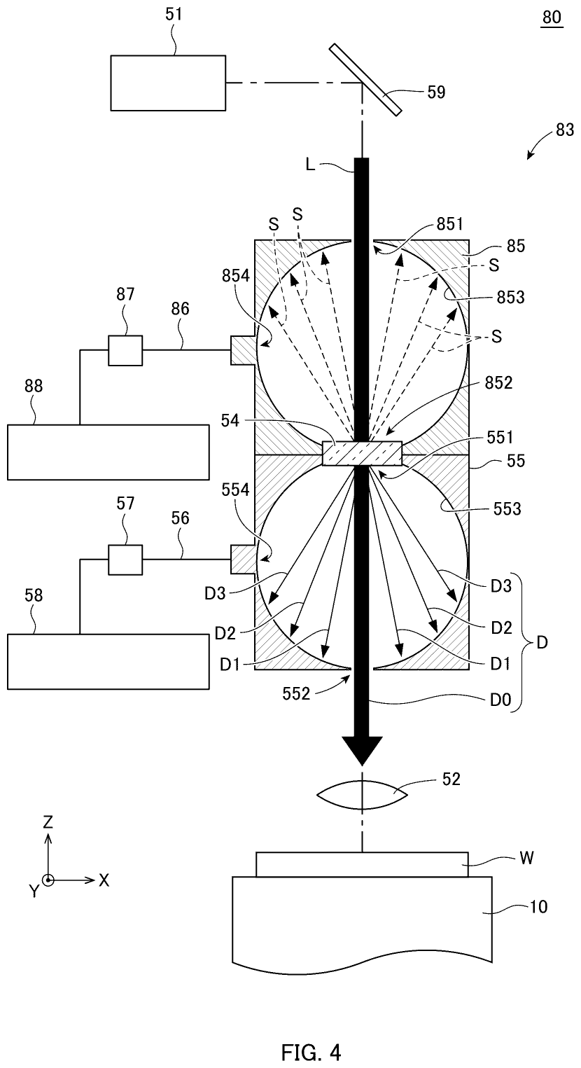

FIG. 4 is a schematic diagram illustrating an exemplary configuration of a laser emitting unit 80 according to a second embodiment. With reference to FIG. 4, a configuration of the laser emitting unit 80, particularly a configuration of a laser intensity measuring device 83 included in the laser emitting unit 80, will be described in detail.

The laser emitting unit 80 differs from the laser emitting unit 50 of the first embodiment in having the laser intensity measuring device 83 in place of the laser intensity measuring device 53. The laser intensity measuring device 83 includes the diffraction optical element 54, two integrating spheres (integrating sphere 55 and integrating sphere 85), two sensors (sensor 57 and sensor 87), and two intensity calculation units (intensity calculation unit 58 and intensity calculation unit 88). The laser intensity measuring device 83 differs from the laser intensity measuring device 53 of the first embodiment in having an additional set of the integrating sphere 85, the sensor 87, and the intensity calculation unit 88. The two sets of integrating spheres, sensors, and intensity calculation units included in the laser emitting unit 80 are not particularly limited in configurations thereof but may be, for example, in the same configurations.

The integrating sphere 85 is disposed on the incident side of the integrating sphere 55 such that the entrance port 551 and the exit port 552 of the integrating sphere 55 and an entrance port 851 and an exit port 852 of the integrating sphere 85 are aligned in line along the optical axis of the condenser 52, and such that the entrance port 551 of the integrating sphere 55 contacts the exit port 852 of the integrating sphere 85. In other words, the integrating sphere 85 is the second integrating sphere disposed on the incident side of integrating sphere 55, through which the laser beam L passes before entering the entrance port 551.

In the laser emitting unit 80, the diffraction optical element 54 is located at a boundary between the entrance port 551 and the exit port 852, so as to block both the entrance port 551 and the exit port 852. Accordingly, the scattered light S, which is a part of the laser beam L entering through the entrance port 851 and scattered on the incident surface of the diffraction optical element 54 without passing, impinges on the inner wall 853 of the integrating sphere 85.

The sensor 87 is the second sensor that measures the intensity of the scattered light S, resulting from the laser beam L scattering on the incident surface of the diffraction optical element 54 and reflected by the inner wall 853 of the integrating sphere 85. The sensor 87 may be, as well as the sensor 57, a photodetector including a photodiode or a thermal sensor including a thermopile. The scattered light S enters the sensor 87 via an optical fiber 86 through the exit port 854.

The intensity calculation unit 88 calculates the intensity of the laser beam L entering the laser intensity measuring device 83 or the intensity of the diffracted beam D0 exiting the laser intensity measuring device 83 based on the output signal from the sensor 87. More specifically, the intensity calculation unit 88 calculates the intensity of the laser beam L or the intensity of the diffracted beam D0 based on the measured intensity of the measurement laser beam by the sensor 87 and the reflectance of the incident surface of the diffraction optical element 54.

In the laser intensity measuring device 83 and the laser processing apparatus including the laser intensity measuring device 83 according to the present embodiment, during the laser measuring method and the measuring step in the laser processing method shown in FIG. 3, the intensity of the measurement laser beam may be measured using both the sensor 57 and the sensor 87. The sensor 57 measures the intensity of diffracted beams other than the zero-order diffracted beam that pass through the diffraction optical element 54, similarly to the first embodiment. On the other hand, the sensor 87 measures the intensity of the scattered light having been scattered on the incident surface of the diffraction optical element 54.

Optionally, as in the first embodiment, the calculation step may be performed in addition to the measuring step. The intensity calculation unit 58 and the intensity calculation unit 88 may calculate the intensity of the laser beam L or the diffracted beam D0 based on the measurement results from the sensor 57 and the sensor 87, respectively.

As described above, even with the laser intensity measuring device 83 according to the present embodiment, the intensity of the laser beam may be measured while the wafer W is being processed with the laser beam. Moreover, the laser processing apparatus according to the present embodiment may be used to irradiate the wafer W with the laser beam while measuring the intensity of the laser beam. According to the laser intensity measuring device 83 and the laser processing apparatus of the present embodiment, similarly to the first embodiment described above, laser processing may be continued without being interrupted by measurement of the laser intensity, and the productivity of laser processing with the wafer W may be improved. Moreover, as in the first embodiment, the intensity of the incident laser beam or the intensity of the exiting laser beam may be calculated based on the measurement results. According to the laser processing apparatus of the present embodiment, as well as the laser processing apparatus 1 in the first embodiment, not only productivity but also quality of laser processing may be improved.

Furthermore, the laser intensity measuring device 83 of the present embodiment is configured such that the integrating spheres (integrating sphere 55 and integrating sphere 85) are disposed on both the incident side and the exit side of the diffraction optical element 54, and the intensities of the spatially integrated measurement laser beams are measured by respective sensors (sensor 57 and sensor 87). Moreover, the intensity of either the incident laser beam or the exiting laser beam may be calculated based on the intensity of the measurement laser beam measured by either of the sensors (sensor 57 or sensor 87).

According to this configuration, levels of the intensities of the laser beams entering the sensor 57 and the sensor 87 may be set to be largely different. Specifically, for example, if the diffraction efficiency of the first or higher-order diffracted beams of the diffraction optical element 54 is approximately between 0.1% and 1%, and the reflectance at the incident surface of the diffraction optical element 54 is approximately between 0.01% and 1%, then the intensity of the measurement laser beam entering the sensor 57 may be increased to at most 100 times greater than the laser beam entering the sensor 87. By providing a plurality of sensors that may receive light of significantly different intensities, even if the intensity of the laser beam L entering the laser intensity measuring device 83 varies greatly depending on the material of the workpiece or the processing conditions, an intensity of the light to be received in at least one of the sensors may be maintained within a limited intensity range that is measurable by the sensor.

Therefore, according to the laser intensity measuring device 83 and the laser processing apparatus of the present embodiment, the intensity range of the laser beam L may be widened compared to the laser intensity measuring device 53 and the laser processing apparatus 1 in the first embodiment. In particular, the laser intensity measuring device 83 and the laser processing apparatus of the present embodiment may be preferable in a configuration where the laser intensity measuring device 53 with a photodiode sensor handles a relatively intense laser beam. This is because photodiodes generally offer higher sensitivity and faster response time than thermopiles, but tend to saturate easily and lack high durability under high-temperature conditions. In the configuration with a plurality of sensors as described above, the sensor 87 to receive a less intense laser beam may be used for measurement when the laser beam L is intense, and sensor 57 to receive a more intense laser beam may be used when the laser beam L is less intense.

Embodiments of the present disclosure may not necessarily be limited to the configurations described above or in the modified example but may be modified, substituted, or altered in various ways without departing from the spirit of the technical idea of the present disclosure. Furthermore, if the technical idea of the present disclosure may be realized in a different way due to technological progress or other derived technology, it may be implemented with use of the method. Therefore, the claims cover all embodiments that may be included within the scope of the technical idea of the present disclosure.

The above embodiments presented examples, where the laser intensity measuring device is equipped with a transmissive diffraction optical element, but the laser intensity measuring device may be equipped with a reflective diffraction optical element in place of the transmissive diffraction optical element. However, the laser intensity measuring device equipped with the transmissive diffraction optical element may be preferable in that bending of the optical path within the laser intensity measuring device is avoidable. By avoiding bending of the optical path, the direction of the processing laser beam remains unchanged even if the measuring device is disposed on the optical path of an existing laser processing apparatus, thus enabling easier application to existing equipment.

Moreover, the above embodiments presented examples, where the zero-order diffracted beam among the plurality of branch beams is used as the processing laser beam, and the other orders of diffracted beams are used for measurement. However, combination of the processing laser beam and the measurement laser beam is not necessarily limited as long as a diffracted order with high diffraction efficiency is selected as the processing laser beam. In the meantime, a configuration using the zero-order diffracted beam as the processing laser beam is preferable in a view that the diffraction angle does not depend on the wavelength of the laser beam. By maintaining the diffraction angle independent from the wavelength, the laser intensity measuring device may be used without adjustment even if the laser wavelength is changed depending on the workpicce. In the configuration where the zero-order diffracted beam from the transmissive diffraction optical element is used as the processing laser beam, moreover, bending of the optical path may also be avoided, and the configuration may be applied to existing laser processing apparatuses easily.

The above embodiments presented examples, where the transmissive diffraction optical element is arranged at the entrance port of the integrating sphere; however, the arrangement of the diffraction optical element is not limited. For example, the diffraction optical element may be located apart from the entrance port or inside the integrating sphere. For another example, if the diffraction optical element is a reflective diffraction optical element, the diffraction optical element may be arranged at the exit port of the integrating sphere. Therefore, either the laser beam before being branched by the diffraction optical element or the plurality of branch beams after being branched by the diffraction optical element may enter the integrating sphere through the entrance port. Meanwhile, the configuration where the transmissive diffraction optical element is located at the entrance port is preferable in that all diffracted beams are directed into the integrating sphere without leakage while preventing scattered light scattering on the incident surface of the transmissive diffraction optical element from entering the integrating sphere. This enables accurate calculation of intensity of the incident laser beam or the exiting laser beam based on the measured intensity and diffraction efficiency, allowing more precise control of laser beam intensity and further improvement in the quality of laser processing.

The embodiments described above presented examples of the configuration in which the integrating sphere and the sensor are connected via the optical fiber, but optionally, the sensor may be provided on the inner wall of the integrating sphere. Moreover, while the examples showed the laser intensity measuring device including the intensity calculation unit, the intensity calculation unit may be provided externally, for example, as a part of the controller of the laser processing apparatus.

Moreover, the embodiments described above presented examples in which the controller of the laser processing apparatus controls the intensity of the laser beam output from the oscillator based on the intensity of the incident laser beam or the intensity of the exiting laser beam calculated by the intensity calculation unit. However, the intensity of the laser beam may not necessarily be controlled based on the calculated intensity but may be controlled based on the intensity measured directly by the sensor. When the relationship between the intensity measured by the sensor and the intensity of the processing laser beam is known, the intensity of the laser beam may be adjusted based on the intensity measured by the sensor such that the processing laser beam may attain the desired intensity.

Moreover, the above embodiments presented examples where the laser intensity measuring device 53 is located on the optical path between the laser oscillator 51 and the condenser 52. However, the laser intensity measuring device 53 may not necessarily located at this position but may be arranged anywhere on the optical path of the laser beam from the laser oscillator 51 to the wafer W when the intensity of the laser beam is measured. For example, the laser intensity measuring device 53 may be arranged such that the condenser 52 is located between the laser oscillator 51 and the laser intensity measuring device 53. In such a case, a beam damper may be located at the exit port 552 of the laser intensity measuring device 53. As such, the laser intensity measuring device 53 may measure the laser beam intensity while the wafer W is being processed with the laser. Meanwhile, the intensity of the laser beam may not necessarily be measured while the wafer W is being processed with the laser.

Moreover, in the embodiments described above, the branching step, the measuring step, and the processing step were described in this given sequence, but these steps may be performed in any order as long as the steps do not conflict, and/or two or more of the steps may also be performed in parallel. For example, the processing step may precede the measuring step, or the measuring step and the processing step may be performed in parallel.

In the context of the present disclosure, the phrase “based on A” does not necessarily mean “based solely on A,” but rather means “based on at least A.” In other words, “based on A” may also mean “based on B in addition to A.”

In the context of the present description, ordinal terms such as “first,” “second,” and the like used to modify nouns do not limit the number or order of the elements they describe. These terms are used merely to distinguish multiple elements from one another and do not imply any priority or exclusion. Therefore, the identification of a “first” and “second” element does not imply that the “first” precedes the “second,” nor does it preclude the existence of a “third” element.

As described above, the laser intensity measuring device according to the present disclosure may measure an intensity of a laser beam and use the laser beam for processing simultaneously. Thus, the invention is advantageous in fields such as semiconductor manufacturing, where high levels of precision and productivity are required.

What is claimed is:

1. A laser intensity measuring device, comprising:
a diffraction optical element configured to split a laser beam into a plurality of branch beams;
an integrating sphere including an entrance port through which one of the laser beam or the plurality of branch beams enters the integrating sphere, an exit port through which at least one of the plurality of branch beams exits the integrating sphere, and an inner wall on which the other of the plurality of branch beams impinge; and
a sensor configured to measure an intensity of the other of the plurality of branch beams reflected by the inner wall.

2. The laser intensity measuring device according to claim 1, wherein the diffraction optical element is a transmissive diffraction optical element and is disposed at the entrance port.

3. The laser intensity measuring device according to claim 2, further comprising:
a second integrating sphere through which the laser beam passes before entering the entrance port of the integrating sphere; and
a second sensor configured to measure an intensity of scattered light resulting from the laser beam scattering on an incident surface of the diffraction optical element and reflected by an inner wall of the second integrating sphere.

4. The laser intensity measuring device according to claim 1, wherein the sensor is a photodiode.

5. The laser intensity measuring device according to claim 1, wherein a zero-order light among the plurality of branch beams exits the integrating sphere through the exit port.

6. The laser intensity measuring device according to claim 1, further comprising an intensity calculation unit configured to calculate intensity of one of the laser beam or the at least one of the plurality of branch beams based on the intensity of the other of the plurality of branch beams and a diffraction efficiency of the diffraction optical element.

7. A laser processing apparatus comprising:
the laser intensity measuring device according to claim 1; and
an oscillator configured to emit the laser beam,
wherein a workpiece is irradiated with the at least one of the plurality of branch beams exiting through the exit port.

8. The laser processing apparatus according to claim 7, wherein the sensor measures the intensity of the other of the plurality of branch beams while the at least one of the plurality of branch beams is irradiating the workpiece.

9. A method for measuring a laser intensity, comprising:
splitting a laser beam into a measurement laser beam and a processing laser beam, including:
causing the laser beam to enter a diffraction optical element;
causing a plurality of branch beams branched from the laser beam by the diffraction optical element to enter an integrating sphere through an entrance port of the integrating sphere; and
directing at least one of the plurality of branch beams to an exit port of the integrating sphere and directing the other of the plurality of branch beams to an inner wall of the integrating sphere, and
measuring an intensity of the other of the plurality of branch beams reflected by the inner wall.

10. A method for laser processing, comprising:
splitting a laser beam into a measurement laser beam and a processing laser beam, including:
causing the laser beam to enter a diffraction optical element;
causing a plurality of branch beams branched from the laser beam by the diffraction optical element to enter an integrating sphere through an entrance port of the integrating sphere; and
directing at least one of the plurality of branch beams to an exit port of the integrating sphere and directing the other of the plurality of branch beams to an inner wall of the integrating sphere,
measuring an intensity of the other of the plurality of branch beams reflected by the inner wall, and
irradiating a workpiece with the at least one of the plurality of branch beams exiting the exit port.
